(19) United States
(12) Patent Application Publication
(10) Pub. No.: US 2012/0197728 A1
(43) Pub. Date: Aug. 2, 2012

(54) SINGLE ACTION ACCESS TO CONTEXT SPECIFIC CONTENT AT A MOBILE DEVICE

(75) Inventors: Michael Luna, San Jose, CA (US); Ross Bott, Half Moon Bay, CA (US)

(73) Assignee: Seven Networks, Inc.

(21) Appl. No.: 13/360,470

(22) Filed: Jan. 27, 2012

Related U.S. Application Data
(60) Provisional application No. 61/436,941, filed on Jan. 27, 2011.

(51) Int. Cl. G06Q 30/02; G06F 3/048

(52) U.S. Cl. 705/14.64; 715/764

(57) ABSTRACT

Systems and methods for single action access to context specific content at a mobile device are disclosed. In one aspect, embodiments of the present disclosure include a method, which may be implemented on a system, for user interface features, also referred to as “hot buttons” which can enhance a mobile user environment or mobile application by linking to real time or near real time information outside of one's social network to include selected web content, within a single dashboard. Hot buttons provide a place to surface dynamic outside of messaging and mobile application contexts. Since many large content providers earn revenue only from site visits by users, hot buttons can provide an ever-present link to the content site, while providing value over a simple URL, since selected context specific or relevant content is being pushed or aggregated dynamically to be accessed via the hot button.

### CLAIM OF PRIORITY

This application claims priority to U.S. Provisional Patent Application No. 61/436,941 entitled “HOT BUTTONS,” which was filed on Jan. 27, 2011, the contents of which are expressly incorporated by reference herein.

### FIELD OF TECHNOLOGY

The present disclosure relates generally to a user environment and more particularly to a mobile user environment enabling single action access to content including third party content or promotional content that is specific or relevant to mobile device activity in a mobile environment.

### BACKGROUND

As our day to day activities become ever more reliant on support or enhancement via applications or other software tools, such as mobile applications/services, a tremendous opportunity exists in mobile advertising as a growing source of potential monetization. For example, the extensive use of mobile devices for SMS, email messaging applications, instant messaging (IM) applications, or other messaging applications for every day communications and various tasks, in-application advertising, if leveraged properly has the potential to become a significant source of funds. However, there has been a reluctance among subscribers to accept advertising in mobile messaging due to either lack of interest, lack of relevance of the material, or the intrusive nature of the manner in which the advertisements or other promotional content is presented in a mobile setting.

### BRIEF DESCRIPTION OF THE DRAWINGS

FIG. 1A illustrates examples of devices with user environments able to provide single action access to content at a mobile device.

FIG. 1B illustrates examples of devices with user environments able to provide single action access to content including third party content or promotional content that is specific or relevant to mobile device activity in a mobile environment with support of servers and services across one or more networks.

FIGS. 1C-D depict the interaction between a host server with third party hosts or services to provide context specific or relevant content to a mobile device.

FIG. 2 depicts a block diagram illustrating example components of mobile device architecture which provides capabilities including user interface features and functions for streamlined access including single action access to context specific/context relevant content at a mobile device.

FIG. 3 depicts a block diagram illustrating example components of a context-specific content linking agent to enable single action access to content based on mobile activity or other context at a mobile device.

FIG. 4 depicts a block diagram showing contact mapping of a user's contacts across multiple sources into a single contact database.

FIG. 5 depicts a flow chart illustrating example processes through which single action access to content which is context specific or relevant can be enabled via a mobile user environment.

FIG. 6 depicts a flow chart illustrating an example process for enabling delivery of mobile activity relevant targeted advertisements.

FIG. 7 depicts an example screenshot of user interface features (e.g., hot buttons) depicted in a view with an email inbox.

FIG. 8 depicts an example screenshot showing how multiple applications, their events, updates, and the associated contacts which are typically scattered across multiple different user interfaces can be unified in a single interface in a mobile user environment also having user interface features allowing single action access to third party content or promotional content which may be context relevant.

FIGS. 9A-B depict example screenshots of a unified user interface for accessing contacts, applications/updates, and indication of a preferred communication channel of the active contact which can be activated to initiate communication with the active contact and also to invite a contact to join a third party service accessed using one or more hot buttons.

FIG. 10 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure include systems, apparatuses, and methods for generating user interface elements on a mobile device, and more specifically, to the generation of interactive user interface elements capable of being dynamically updated in real-time or near real time with selected information.

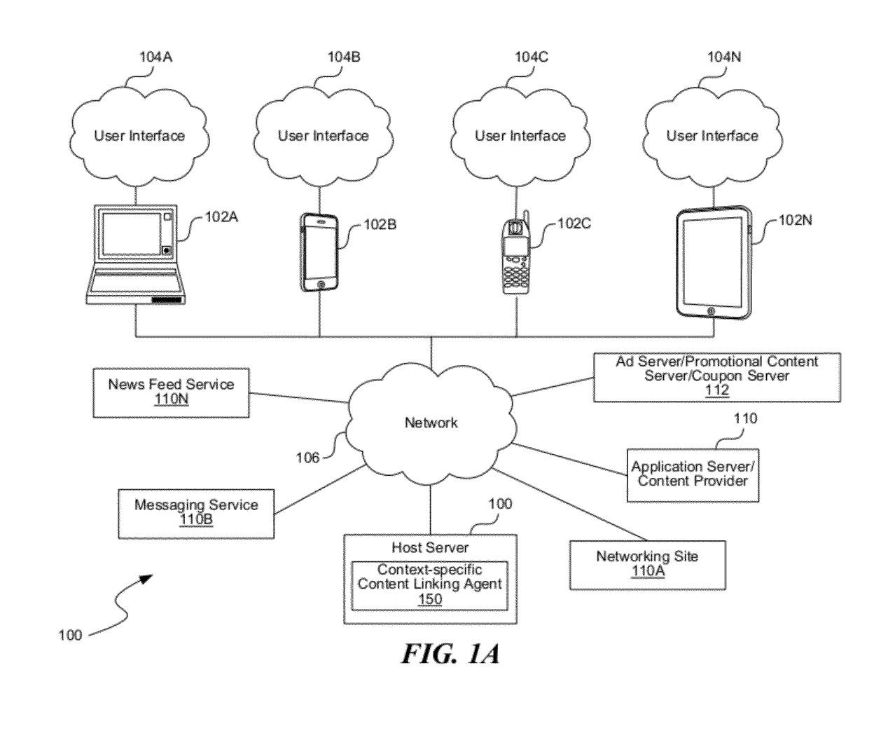

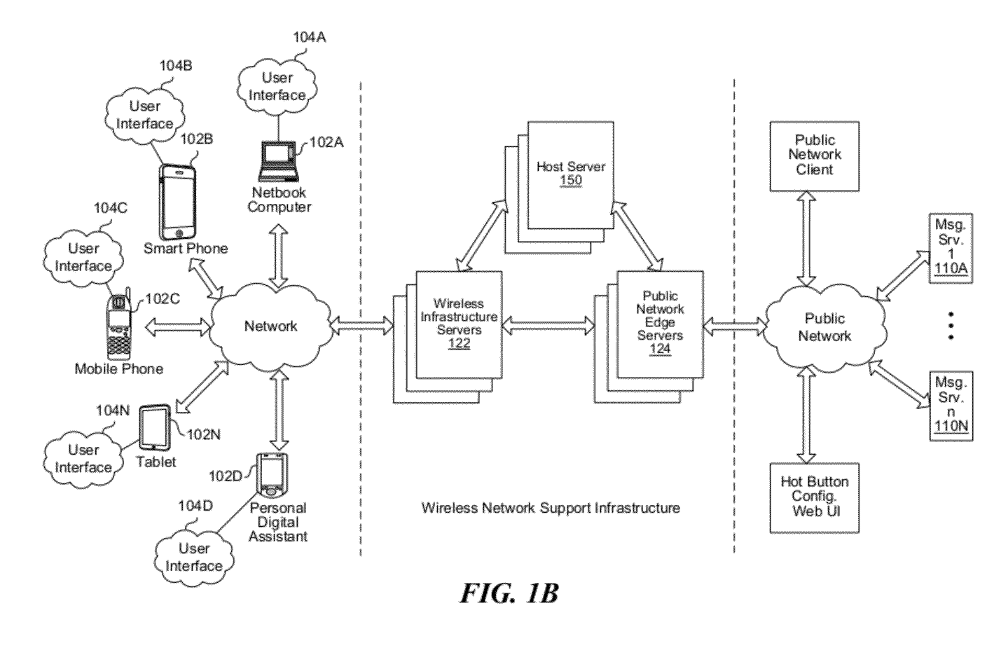

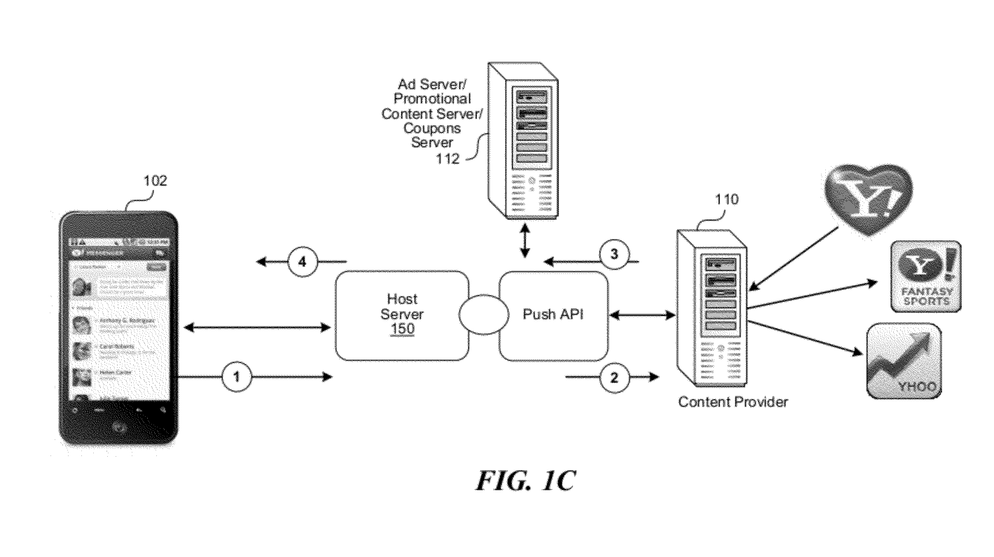

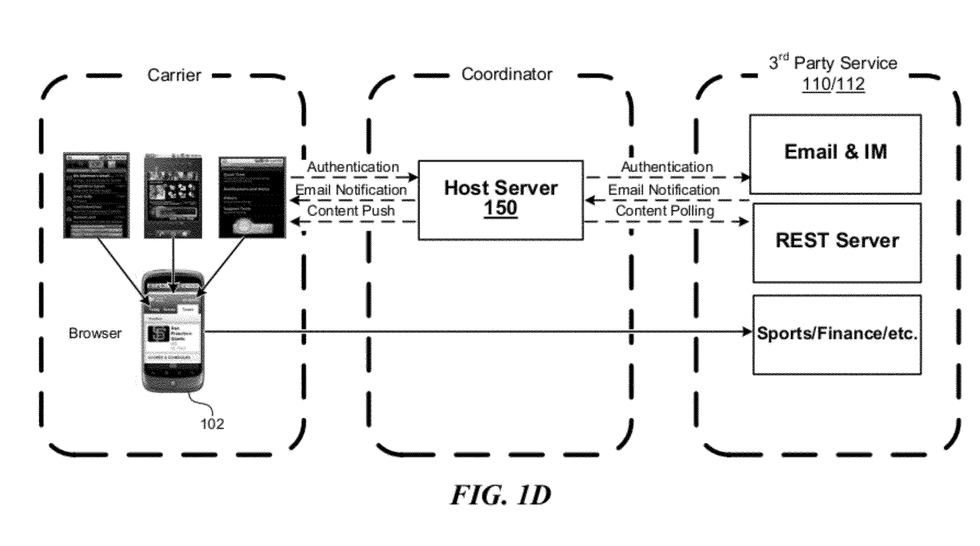

FIG. 1A illustrates examples of devices 102A-N with user environments able to provide unified access and management of events across multiple applications 110 and the associated contacts.

The client devices 102A-N can be any system and/or device, and/or any combination of devices/systems that is able to establish a connection with another device, a server and/or other systems such as host server 100 and/or application server/content provider 110. Client devices 102A-N each typically include a display and/or other output functionalities to present information and data exchanged between among the devices 102A-N and/or the host server 100 and/or application server/content provider 110.

For example, the client devices 102A-N can include mobile or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g., an iPad), a handheld console, a handheld gaming device or console, an iPhone, and/or any other portable, mobile, handheld devices, etc. In one embodiment, the client devices 102A-N and host server 100/app server 110 are coupled to a network 106. In some embodiments, the devices 102A-N and host server 100 may be directly connected to one another.

The input mechanism on client devices 102A-N for providing single action access to context relevant content or ads, can include touch screen keypad (including single touch, multi-touch, gesture sensing, etc.), a physical keypad, or a combination of the above. The user interface and environment features herein can be actuated and interacted with using any conventional or known input device including but not limited to physical keyboard, touch screen display, motion sensor, microphone, mouse, other types of pointer devices and any additional input device. The user interface and environment features and functionality can be provided locally by the client devices 102A-N and used to access applications (e.g., including mobile applications), accounts, websites, services, documents, files, media, or any other content such as those provided by a third party hosts (e.g., application server/content provider of various services 110A-N or ad server 112).

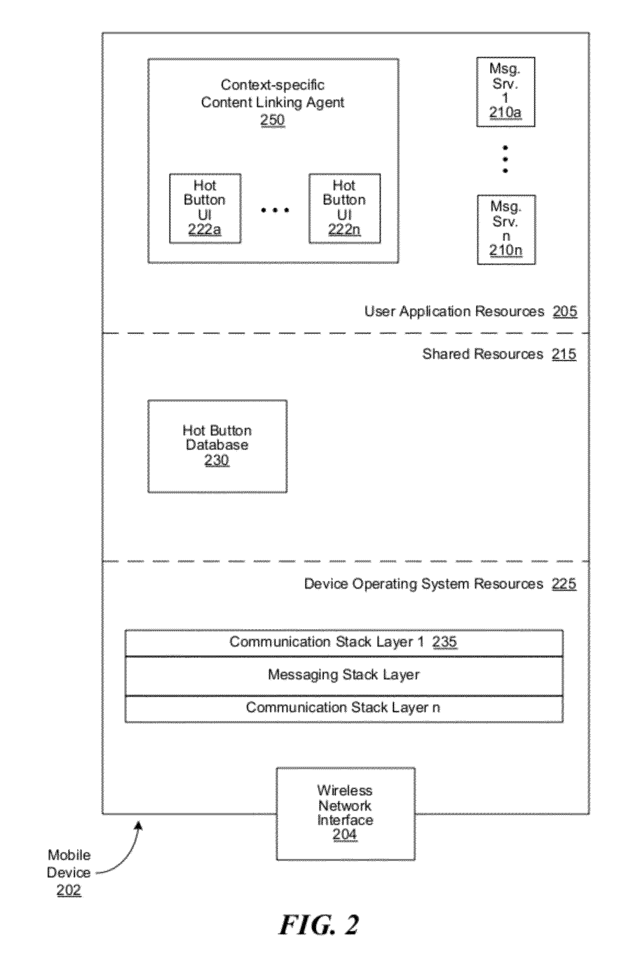

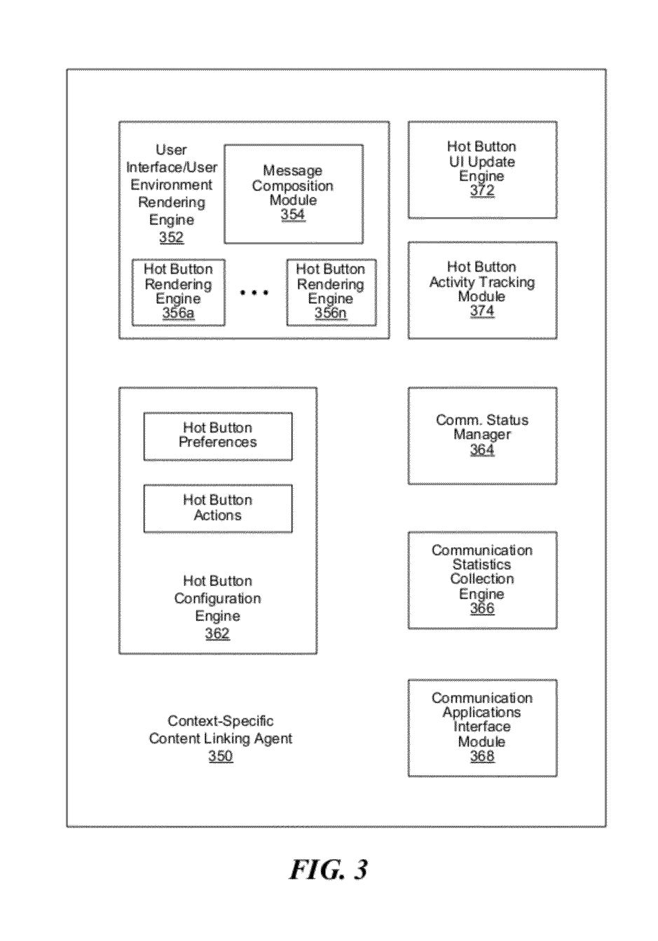

The user interface features and environment for access to context and/or user specific content or promotional content can be provided locally by the devices 102A-N through the mobile device manufacturer, provided through the device operating system, by a network service provider, through a downloaded widget from a third party site, network service provider, or from the host server 100. The user interface features and environment for access to context and/or user specific content or promotional content may also be provided and enabled on a per application/content basis based on the services provided by the application server/content provider 110 via a contact-oriented messaging application. Functions and techniques performed by the context-specific content-linking agent 150 at the mobile device and the related components therein are described in detail with further reference to the example of FIGS. 2-3.

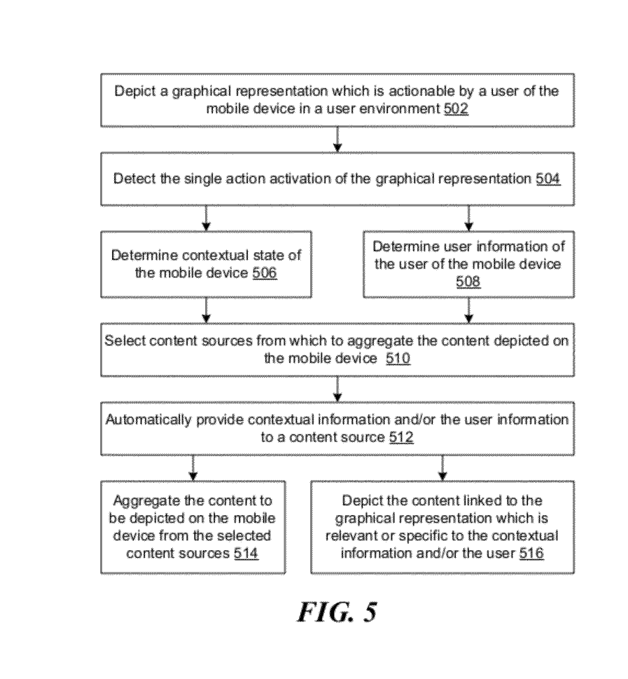

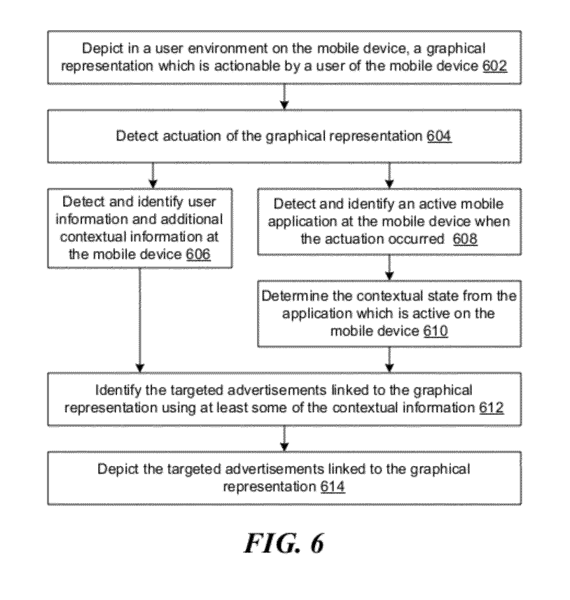

In one embodiment, context-specific content-linking agent functionalities are in part or in whole provided remotely to the devices 102A-N, for example by the host server 100. For example, the host server 100 can include a context-specific content-linking agent 150 accessible over the network 106 by devices 102 to enable features such as UI or UE features for single action access to device and/or user specific content, such as those that will be described with further references to description associated with example flow charts FIGS. 5-6.

The context-specific content-linking agent functionalities, when provided remotely, may be accessed by the devices 102 in the cloud. In addition, the UI/UE configured as a as result thereof, may be streamed to the devices 102 on demand, for example, based either on local processes occurring on the device 102 itself or based on processes driven by applications or services provided by the app server/content provider 110.

Functions and techniques performed by a user environment rendering engine for unified application and contacts management, which can reside on the client devices 102 in part or in whole and/or or host server 100 in part or in whole and the components therein are described in detail with further references to the examples of FIGS. 2-3.

The network 106, over which the client devices 102A-N, the host server 100, and/or app servers 110A-N communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, and other services through any known or convenient protocol, such as, but is not limited to, the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

FIG. 1B illustrates examples of devices 102A-N with user environments able to provide single action access to content including third party content or promotional content that is specific or relevant to mobile device activity in a mobile environment with support of servers 112, 150 and 114 and services 110A-N across one or more networks.

Mobile devices 102A-N may communicate with one another and with non-mobile devices through a wireless network, a wireless network support infrastructure, a public network and/or multiple services 110A-N. The wireless network may incorporate and/or participate in a communication network utilizing any suitable wireless communication protocol including wireless telephony protocols and wireless internet protocols. The public network may incorporate and/or participate in a global computer network. In at least one embodiment, the public network may be replaced by and/or supplemented with one or more private and/or enterprise networks.

The application hosts/services 110A-N may correspond to different modes or types of communication. For example, the application hosts/services 110A-N can include voicemail, email, a short messaging service (e.g., SMS), chat (e.g., internet relay chat), instant messaging (IM), fixed length text messages viewable by a set of subscribers (e.g., “TWITTER”), and personal status updates viewable by a set of authorized subscribers (e.g., “FACEBOOK”). The messages communicated with the services 110A-N can incorporate any suitable media format including plain text, formatted text, rich text, graphics, images, audio, video, animations and simulations. In one embodiment, one or more of the services 110A-N can be incorporated into the wireless network support infrastructure.

The wireless network support infrastructure may include a set of wireless infrastructure servers facilitating a wide variety of wireless infrastructure services including communication connection switching and/or routing, service provisioning and/or repair, resource usage monitoring and/or billing, as well as security and/or anti-fraud services. The wireless network support infrastructure may further include a set of public network edge servers that facilitate and govern communication between the wireless network and the public network.

Still further, the wireless network support infrastructure can include a host server 150 which may further include a set of “hot button” infrastructure servers collectively configured to facilitate the configuration and operation of the user interface/user environment features (e.g., or herein referred to as “hot buttons”) which can provide streamlined access (e.g., single action access) to content which is context specific/relevant at mobile devices. The content linked for access can be dynamic and updated in real-time, for example, including real-time content which is also relevant to activity at the mobile device (e.g., what the user is doing, viewing, which applications are running, the current time, temperature, etc.). The content can further include promotional content including ads and/or coupons/electronic coupons which can be linked and provided by access of the user interface feature (hot button). The promotional content delivered by way of the user interface features can include ads that are targeted to the user, the mobile device, and/or the specific activity at the mobile device.

In one embodiment, the user interface/environment also includes contacts of a user of contact-oriented messaging may each make use of multiple of the messaging services for various purposes. Various aspects of the disclosed user interface features (e.g., “hot buttons”) may be customized and/or configured with a web user interface (e.g., an application programming interface or a graphical user interface) accessible via the public network (as shown in FIG. 1B) and/or incorporated into the wireless network support infrastructure. Such a user interface may be accessible with a public network client (e.g., a personal computer incorporating a web browser) connected to the public network and/or a mobile device (e.g., incorporating a mobile web browser).

FIGS. 1C-D depict the interaction between a host server 150 with third party hosts or services 110/112 to provide context specific or relevant content to a mobile device.

User interface features such as those referred to herein as “hot buttons” can help monetize various mobile applications including messaging applications, such as, email messaging applications, instant messaging (IM) applications, SMS applications, and unified messaging applications. The disclosed user interface features (“hot buttons”) can provides a mechanism to deliver mobile ads at one or more levels of indirection. For example, hot buttons can be actuated to link to content sites that use page views to present advertisements, and the content sites may reward the referral with a fee.

In one embodiment, a hot button can incorporate and/or be associated with a corresponding region of a display (e.g., of a mobile device visual display) that is presented within a user interface element (e.g., a screen) of another application. The hot button may be part of that application. The hot button may display one or more pieces of content. Such content may be dynamic, for example, periodically updated from a content source (e.g., third party source 110/112) within a cloud of networked computing services. Such content may come from directly from a fixed source within the cloud, and/or information derived from the handset can be utilized in updating the information. For example, a hot button may present the weather in a known location such as the subscriber's house, or gather the GPS location of the handset and use that to fetch and present the weather at the subscriber's current location.

In one embodiment, updates can be provided (e.g., pushed and aggregated) from the content source by the host server 150. Examples of pushed content include one or a few stock quotes of key interest to the subscriber, one or two auction status data points from auctions (e.g. electronic auctions such as those held by eBay) in which the user is participating, and/or one or two sports scores.

Selecting a hot button (e.g., by touch or gesture with respect to a touch-sensitive display screen) can link into the source of the content 110/112, using the specific parameters implied in the information presented in the hot button. For example, selecting a hot button presenting the weather at the house could link to a weather page for the town/city of ones house at a 3rd party provider of such weather pages (e.g., web pages), selecting a hot button presenting the weather at the current global positioning system (GPS) location of the handset could link to a weather page for the current location of the handset at the 3rd party weather site 110/112, selecting the location of a hot button showing two sports scores could go to a homepage for the sport at a 3rd party provider of sports pages (e.g., web pages).

The content source that is linked can include one or more web pages or applications. The content can be displayed with a web page browser application present on a mobile device. Once in the browser on device 102, additional pages can be surfed. When the browser is exited, the display (e.g., the visual display of the mobile device) can return to the application incorporating the hot button. Should the default behavior of the mobile device be to return to a “home screen” upon exiting the browser, such default behavior may be overridden by the hot button.

This aspect of the hot button can provide a significant usability advantage, as one isn't losing the context of one's original activity when spending a moment or two to check further on information through using the hot button. It is also possible to hotlink to a non-browser application on a mobile device that is specific to particular types of content. For example, an eBay auction hot button could hotlink to an eBay client if one existed on the mobile device (or offer to download such a client if it existed).

A hot button can have information pushed from more than one content source 110/112 (e.g., facilitated via the host server 150 or via a local agent residing on the mobile device 102). For example, a hot button which represents “all auction statuses”, receive information from, say, three different auction sites (e.g., a wine auction site, and two general electronic auction services). In this case, selecting a hot button should display a popup of the different content sites pushing information to that hot button. In addition, the hot button may be context sensitive to allow the last update to the hot button to be the default site to which to hotlink. For some display surfaces (e.g., mobile device handset screens), in which display real estate is at a premium, such class or group hot buttons may be more desirable than multiple hot buttons each corresponding to one content provider.

For example, as illustrated in FIG. 1C, the device 102 can register for push with the host server 150 in step 1. The server 150 receives the request from the mobile device 102 and registers with the provider 110 or 112. In sequence 3, the content provider 110 or 112 can send push events to the server 150 which then in sequence 4, pushes the events/content to the device 102. A client application on the device 102 can then be notified of the event/content. In some embodiments, the host server 150 polls the third party host 110 or 112 for content or events to be linked to the mobile device 102 by actuation of the hot buttons, as illustrated in FIG. 1D. In addition, email notifications can be used by the third party host 110 or 112 to notify the host server 150 of updates or events to be pushed to the mobile device 102 for linking via a hot button. The host server 150 can also notify the mobile device 102 by email of any updates or events to be accessed/linked via hot buttons.

In one embodiment, hot buttons can play the role of a miniature application or “mini-app.” For example, an auction hot button may perform a subset of the functionality of a corresponding auction application. The auction hot button may provide updates on auction in which the user is participating, while the full auction application may be required to subscribe to a new auction, to counter bid, and so forth.

In some embodiments, a hot button recognizes that the activity in many information-centric applications are divided up into two categories: (i) small bursts of user participatory activity (e.g., signing up for a new auction, counter bidding, buying a stock, etc.) and (ii) longer periods of monitoring, waiting for information or content change to arrive, and where real time notification of this change is valuable. The hot button may take over at least part of the functionality relevant to this latter category of activity.

Hot button enabled applications may allow subscribers to earn referral “credits”, which can be applied by subscribers or service carriers (e.g., wireless service carriers) to offset financial costs associated with providing application services, or otherwise redeemed. Hot buttons can also be credited with a portion of the advertising revenue generated from page views and/or application downloads they facilitate.

FIG. 2 depicts a block diagram illustrating example components of mobile device 202 architecture which provides capabilities including user interface features and functions for streamlined access including single action access to context specific/context relevant content at the mobile device 202.

As used in this paper, a “module,” a “manager,” a “handler,” or an “engine” includes a general purpose, dedicated or shared processor and, typically, firmware or software modules that are executed by the processor. Depending upon implementation-specific or other considerations, the module, manager, handler, or engine can be centralized or its functionality distributed. The module, manager, handler, or engine can include general or special purpose hardware, firmware, or software embodied in a computer-readable (storage) medium for execution by the processor. As used in this paper, a computer-readable medium or computer-readable storage medium is intended to include all mediums that are statutory (e.g., in the United States or under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, etc.), but may or may not be limited to hardware.

The mobile device 202 can include multiple messaging applications 210A-N implemented with a set of user application resources 205 of the mobile device 202. The multiple messaging applications 210A-N may correspond to the multiple messaging services or other third party services described above with reference to FIGS. 1A-D. The mobile device 250 can further include a communication stack 235 (e.g., a messaging protocol stack such as a TCP/IP stack) incorporating multiple layers configured to facilitate communication with a wireless network interface 204.

In general, the communication stack 235 is incorporated into and/or implemented with device operating system resources 235 of the mobile device 202. The communication stack 235 in one embodiment includes a messaging stack layer which may be able to monitor characteristics of messages and/or messaging patterns over time to and/or from the messaging applications 210a-n. Such monitored information may be available to a context-specific content linking agent 250, for example, implemented with the user application resources 205 of the mobile device 202.

In one embodiment, the mobile device 202 is coupled to or includes (as illustrated) a hot button database 230 which can be shared with the messaging applications 210A-N and/or the context-specific content linking agent 250. Access to the hot button database 230 may be subject to various controls and/or policies enforced by an operating system or various applications of the mobile device 202. The rules can be set by the platform/device operating system, the user, service provider (network service provider, Internet service provider, etc.) and/or any other mobile applications/agents. For example, different applications may have no access, read-only access, read-update access and/or read-update-create access to the hot button database 230. The hot button database 230 can include authoritative hot button configuration details for the hot buttons of one or more users of the mobile device. Different sets of configurations can be stored for different users of the mobile device 250. In one embodiment, the wireless network support infrastructure can also maintain a back-up copy of the hot button database 230.

FIG. 3 depicts a block diagram illustrating example components of a context-specific content linking agent 350 to enable single action access to content based on mobile activity or other context at a mobile device.

The context-specific content linking agent 350 can include, for example, a user interface rendering engine 352 having a message composition module 354 and hot button rendering engines 256A-N, a hot button user interface update engine 372, a hot button activity tracking module 374, a communication status manager 364, a communication statistics collection engine 366 and/or a communication applications interface module 368. In one embodiment, the hot button configuration engine 362 stores, tracks, updates and maintains hot button preferences and/or hot button actions. Additional or less components/modules/engines can be included in the contact-oriented messaging agent 350.

As used in this paper, a “module,” a “manager,” a “handler,” or an “engine” includes a general purpose, dedicated or shared processor and, typically, firmware or software modules that are executed by the processor. Depending upon implementation-specific or other considerations, the module, manager, handler, or engine can be centralized or its functionality distributed. The module, manager, handler, or engine can include general or special purpose hardware, firmware, or software embodied in a computer-readable (storage) medium for execution by the processor. As used in this paper, a computer-readable medium or computer-readable storage medium is intended to include all mediums that are statutory (e.g., in the United States or under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, etc.), but may or may not be limited to hardware.

The context-specific content linking agent 350 in one embodiment, includes a user interface/user environment rendering engine 352 configured to, for example, maintain, generate, update, customize a graphical user interface. The graphical user interface may include one or more user interface features or elements enabling streamlined access to content (updated dynamically in real time or near real time), such as icons, buttons, drop down menus, lists, boxes, which may be selectable or otherwise actionable via touch screen, scrolling, mouse-over, mouse-click, mouse-hovering, speech, voice, or any other actuation means. These user interface features can otherwise be referred to a “hot buttons” and rendered by the hot button rendering engine 356. A hot button can include a visual representation, a graphical representation, an audio representation, or any of the above or combinations.

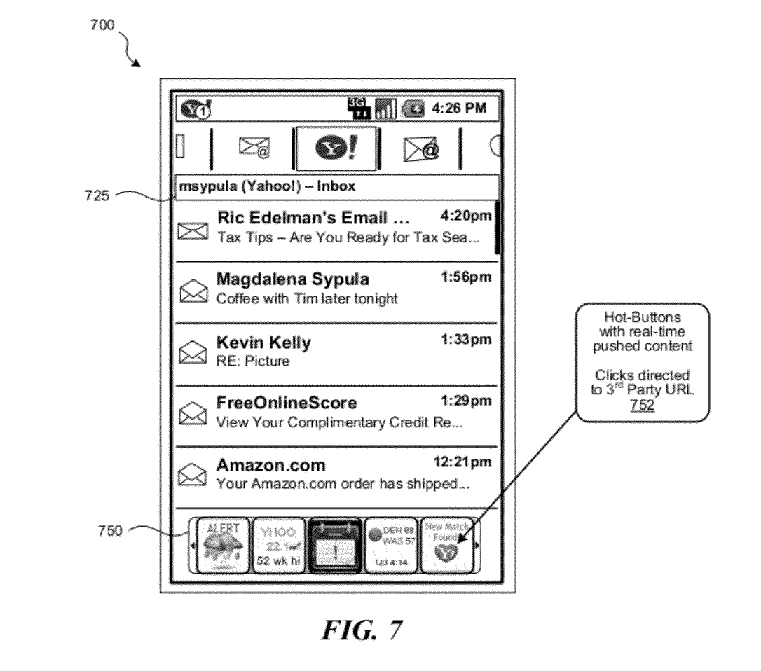

In some instances a hot button can be depicted in a hot button carousel (e.g., carousel 750 as shown in the example screenshot of FIG. 7) among multiple hot buttons of the application user. A hot button carousel can include, for example, 5-10 hot buttons. The hot button carousel may respond to user indications (e.g., touch screen input or other input means) by rotating, scrolling, touch, gesturing, clicking, or otherwise selecting to display different subsets of the hot buttons. The hot buttons that are displayed may be user configured, specific to the user, specific to the device, or specific to an application currently active on the device, specific to a network provider, specific to a device operating system/platform, specific to any contextual information at the mobile device (e.g., date, time, location, weather, service level, etc.) or any combination of the above.

In one embodiment, the hot buttons in the hot button carousel may be updated by a hot button user interface update module 372, for example, using information pushed to the application and/or its host device 202 by one or more of the infrastructure services. User interaction with the hot button carousel and/or the hot buttons may be tracked by a hot button activity tracking module 374. The activity tracking module 374 can further determine user activity or other mobile activity occurring at the mobile device 350, for example, whether the user is on a call, whether the user is on IM, whether a particular application is in the foreground and/or active, whether a particular network is active, etc.

The activity tracking module 374 can track user behavior such as browsing behavior, application usage trends, device usage trends, frequently contacted users, frequently used modes of communication, etc. The activity tracking module 374 can also track mobile application behavior such as device resource (processor, memory) use, network use, amount of data consumed, etc. The activity tracking module 374 can also determine other contextual information including but not limited to time, geographical location, other types of location data, time zone, weather, day of week, network operational status, network traffic, network congestion, etc.

The hot button configuration engine 362 can communicate with the communication status manager 364, the communication statistics collection engine 366, and/or the activity tracking module 374. For example, the configuration engine 362 can use information including contextual information including mobile device activity, application state, and/or user behavior/action to configure the hot buttons such that they can be actuated to allow access to content which is context specific or relevant. The content that is linked can include third party content including web sites, blogs, additional applications, other types of content, promotional content including but not limited to advertisements, coupons, and/or e-coupons etc.

The sources for the linked content can be selected or updated dynamically either in real time or near real time based on user action or other activities at the mobile device. The content presented can be cached content from the sources or the content can be retrieved in real time or near real time at a time when the buttons are activated. Note that content can be aggregated from multiple sources if several sources can provide content that is relevant or may be relevant to a given user and/or mobile device/activity context.

The hot button configuration engine 362, in addition to configuration of and updating the configuration settings for the hot buttons, also maintain configuration settings for the hot buttons. The configuration settings may include hot button preferences such as hot button size, hot button number, hot button update frequency, banned hot buttons and/or hot button types, desired hot buttons and/or hot button types, hot button cache size, hot button resource allocation and/or limit. The configuration settings may further include hot button actions configured for particular hot buttons specifying particular actions or tasks to perform in response to particular user inputs and/or user interactions with the hot buttons, such as linked content, linked content sources, types of content (e.g., ads or no ads, coupons etc.).

In one embodiment, communication with a selected contact may be facilitated by a message composition module 354 of the user interface. The message composition module 354 may provide composition with respect to messages of multiple messaging services and/or applications, and/or facilitate access to mode-specific message composition with the corresponding messaging application. For example, the unified message composition module 354 can cause the communication applications interface module 368 to launch and/or switch to the corresponding messaging application. The message composition module 354 can determine the selected contact's preferred mode of communication, for example, based on the contact's communication preferences stored in the contact database overly and/or algorithmically.

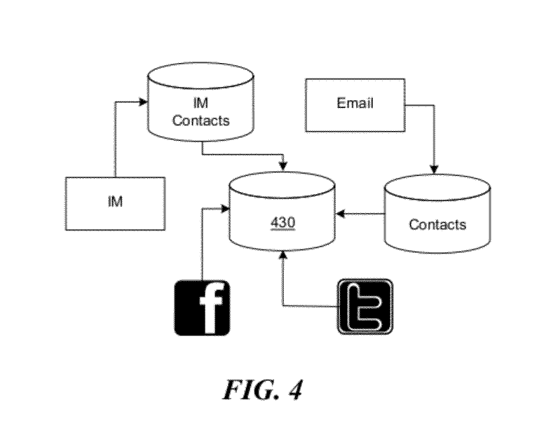

FIG. 4 depicts a block diagram showing contact mapping of a user's contacts across multiple sources into a single contact database 430.

The user's contacts across services or applications, the mobile device, the SIM card, IM services, and/or email contacts can be merged into the single contact database. The contact database 430 is typically accessible by a user via a mobile device but stored remotely (e.g., accessed via a host server 150). The contacts can be aggregated from the mobile device or from remote hosts/services. In some embodiments the contacts can be sync'ed, merged, and/or de-duplicated.

In some instances, an aggregated communication event database, which holds communication events from multiple services (IM, chat, phone, email, tweet, post, etc.), is created. The communications event database can be included in the contact database 430 or it can be a separate database. The communications event database data can be used to infer a preferred communication method for a user or as a data mining source that enables the inference of other information that allows system optimization of the user experience or of the network traffic generated by the user's communication events.

FIG. 5 depicts a flow chart illustrating example processes through which single action access to content which is context specific or relevant can be enabled via a mobile user environment.

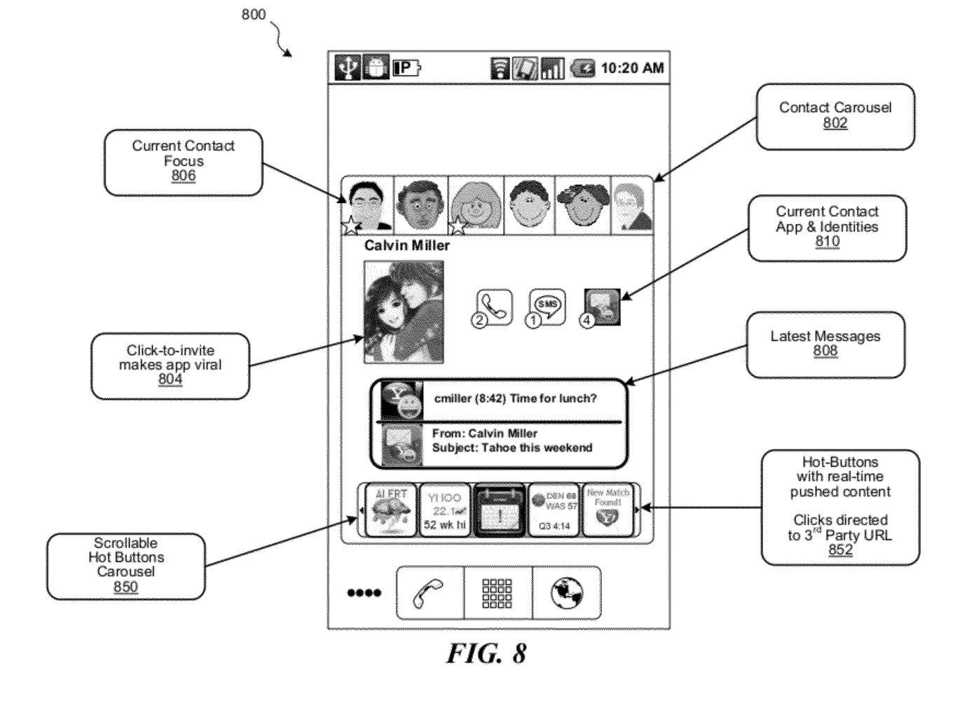

In process 502, a graphical representation which is actionable by a user of the mobile device in a user environment is depicted. The graphical representation can include graphics indicative of the content to be linked when activated, as shown in the example screenshots of FIGS. 7-8. In one embodiment, the graphics illustrated in the graphical representation is user configurable and selectable. In some instances, graphical representation is depicted among multiple graphical representations shown in the form of a carousel having a sequence of images, wherein, the carousel is manipulable via scrolling, clicking, selecting, highlighting, audio, speech, voice or other types of user interface input actions.

The graphical representation can be a standalone feature (e.g., buttons, icons, etc.) depicted in the user interface. The graphical representations can also be integrated in the user environment with an email application, an Internet service provider (ISP) application or network provider application, and/or via other mobile applications or third party content/services.

In process 504, the single action activation of the graphical representation is detected. In one embodiment, the graphical representation is actionable via touch gestures with respect to a physical screen of the mobile device or other types of actions, including mouse over, mouse click actions, or audio/speech-related input mechanisms.

In process 506, contextual state of the mobile device is determined. In one embodiment, the contextual state is related an application which is active on the mobile device. The contextual state can also be related to a geographical location of the mobile device. In process 508, user information of the user of the mobile device is determined. In process 510, content sources from which to aggregate the content depicted on the mobile device are selected, for example, based on the contextual state of the mobile device. In process 512, contextual information and/or the user information are automatically provided to a content source.

In process 514, the content to be depicted on the mobile device can be aggregated from the selected content sources. In some instances, the multiple content sources are updated dynamically based on the contextual state of the mobile device. The selected content sources can be updated periodically either in real time or near real time based on device activity or user activity, for example. The content may further be relevant to a user (e.g., user behavior, user characteristics, user settings) of the mobile device. In general, the content can include third party content including web pages, blogs, forums, live content, multimedia content, news, feeds, promotional content such as advertisements, mobile ads, coupons, offers, or electronic coupons, for example.

In process 516, the content linked to the graphical representation which is relevant or specific to the contextual information and/or the user is depicted on the mobile device. In one embodiment, the contextual information and/or the user information are automatically provided such that content that is specific and relevant to the contextual information is depicted when the graphical representation is actuated.

FIG. 6 depicts a flow chart illustrating an example process for enabling delivery of mobile activity relevant targeted advertisements.

In process 602, a graphical representation which is actionable by a user of the mobile device is depicted in a mobile user environment. In one embodiment, the graphical representation is depicted among multiple graphical representations shown in the form of a carousel of a sequence of images which can be manipulable via a scrolling action to view the multiple graphical representations and additional graphical representations not depicted in the user environment.

In process 604, actuation of the graphical representation is detected. In process 606, user information and additional contextual information are detected and identified. In process 608, an active mobile application is detected and identified at the mobile device when the actuation occurred. In process 610, the contextual state is determined from the application which is active on the mobile device.

In process 612, the targeted advertisements linked to the graphical representation are identified using at least some of the contextual information. In process 614, the targeted advertisements which are relevant or specific to a contextual state of the mobile device that is linked to the graphical representation are depicted. The targeted advertisement can be depicted along with third party content or depicted without additional content.

The user environment may be further populated with graphical user representations of multiple contacts accessible at the mobile device, as shown in the example screenshots of FIGS. 7-8. For example, responsive to detecting a selection of a given representation associated with a contact, modes of communication channels represented by graphical indicators can be presented in the user environment.

FIG. 7 depicts an example screenshot 700 of user interface features (e.g., hot buttons 750) depicted in a view with an email inbox 725.

Hot buttons can be utilized in an application in a variety of ways. For example, within a tabbed inbox approach to email and instant messaging: (i) for an inbox tab specific to an internet service provider (ISP), one or two emails worth of headers may be replaced with a group of 2 to 6 hot buttons, (ii) these buttons may go to content sites within that ISP (e.g., a Yahoo inbox tab would have hot buttons linking to Yahoo content properties), (iii) in this usage, the hot button portion of the inbox may act like a second window, e.g., scrolling the inbox, selecting a header to see the message, and other inbox-specific actions would occur just to the mail portion of the inbox 725, not the hot button portion 750.

FIG. 8 depicts an example screenshot 800 showing how multiple applications 810, their events, updates 808, and the associated contacts 802 which are typically scattered across multiple different user interfaces can be unified in a single interface in a mobile user environment also having user interface features 850 allowing single action access to third party content or promotional content which may be context relevant.

The content source may be presented within a sub-window of the application in which the hot button is embedded. For example, if the hot button is located in the unified messaging application, the content could be presented within the main viewing area, in a manner corresponding to the manner in which selecting a contact displays the detailed state of that person in the main window. To accomplish this, the messaging application may need to be capable of rendering hypertext markup language (e.g., HTML) in that main viewing area, e.g., incorporating and/or acting as a mini-browser. It is also possible to provide a customized, push supported rendering of information from the content site within the main viewing area.

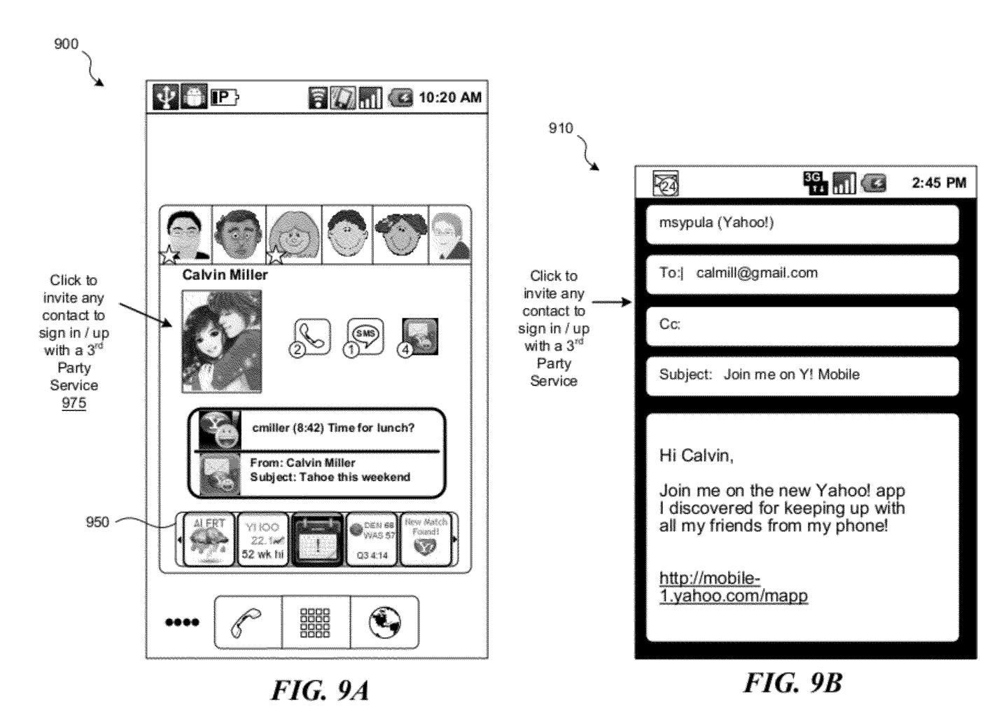

With a messaging application, there can be a second carousel 850 of tiny boxes below the main application viewing area (e.g., symmetric with the carousel 802 of tiny pictures representing frequent contacts at the top of the window). This hot button carousel 850 can be scrollable in the same way as the top contacts carousel. Selecting a hot button 852 in the carousel may hotlink to the source of the content in the same way as described above. In one embodiment, the contacts can be selected (e.g., via 804) to invite the user to join an application or participate in a third party service as further illustrated in FIGS. 9A-B.

FIGS. 9A-B depict example screenshots 900 and 910 of a unified user interface for accessing contacts, applications/updates, and indication of a preferred communication channel of the active contact which can be activated to initiate communication with the active contact and also to invite 975 a contact to join a third party service accessed using one or more hot buttons 950.

The ability to invite users or contacts to join a third party service, hot buttons enhance a messaging application by linking to real time information outside of one's social network to include selected web content, within a single dashboard (e.g., that shown in FIG. 9A). Hot buttons 950 can provide a place to surface real-time content outside of messaging contexts. Hot buttons can drive full application adoption and/or fuller service participation (e.g., more active participation in auctions). Hot buttons provide an ever-present link to the content site, while providing value over a simple URL, since selected information is being pushed real time or near real time to the hot button, and in some instances, context or user specific to the device and/or user. In some instances, content providers (e.g., ISPs) can be charged a fee for referrals to their content properties and hot buttons can be used track such referrals.

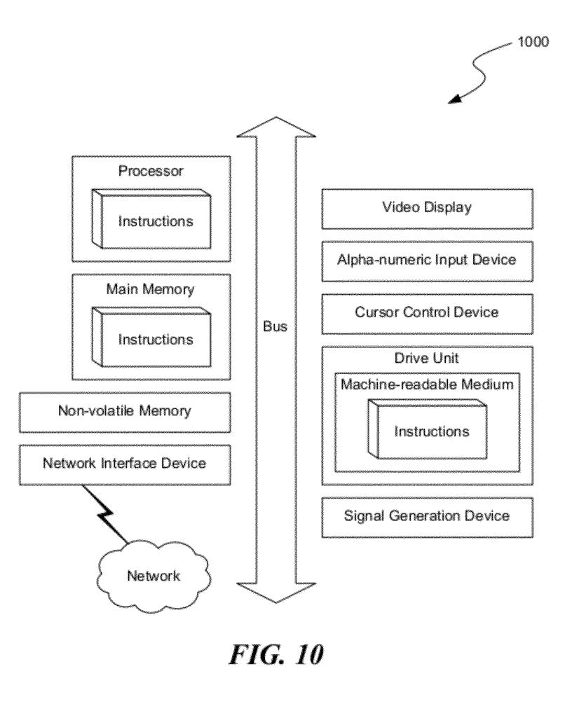

FIG. 10 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the disclosure.

What is claimed is:

1. A method for enabling single action access to content via a mobile device, the method, comprising:
depicting in a user environment on the mobile device, a graphical representation which is actionable by a user of the mobile device;
responsive to detection of the single action activation of the graphical representation, depicting the content linked to the graphical representation;
wherein, the content is relevant and specific to a contextual state of the mobile device.

2. The method of claim 1, wherein, the contextual state is related an application which is active on the mobile device.

3. The method of claim 1, wherein, the contextual state is related to a geographical location of the mobile device.

4. The method of claim 1, wherein, the graphical representation comprises graphics indicative of the content to be linked when activated.

5. The method of claim 1, wherein, the content includes third party content including promotional content.

6. The method of claim 1, wherein, the content aggregated from multiple content sources.

7. The method of claim 6 wherein, the multiple content sources are updated dynamically based on the contextual state of the mobile device.

8. The method of claim 1, further comprising, selecting content sources from which to aggregate the content to be depicted on the mobile device based on the contextual state of the mobile device.

9. The method of claim 1, wherein, the content is further relevant to a user of the mobile device.

10. The method of claim 1, further comprising, automatically providing the contextual information of the mobile device such that content that is specific and relevant to the contextual information is depicted when the graphical representation is actuated.

11. The method of claim 1, further comprising, automatically providing user information of the user of the mobile device such that content that is specific and relevant to the user is depicted when the graphical representation is actuated.

12. The method of claim 1, wherein, the graphical representation is integrated in the user environment with an email application.

13. The method of claim 1, wherein, the graphical representation is integrated in the user environment through an Internet service provider (ISP) application or network provider application.

14. The method of claim 1, wherein, the graphical representation is integrated in the user environment with a mobile application.

15. The method of claim 1, wherein, the graphical representation is integrated in the user environment further depicting representations of multiple contacts.

16. The method of claim 1, wherein, graphics illustrated in the graphical representation is user configurable and selectable.

17. The method of claim 1, wherein, the graphical representation is actionable via touch gestures with respect to a physical screen of the mobile device.

18. A method for enabling delivery of targeted advertisements via a mobile device, the method, comprising:
depicting in a user environment on the mobile device, a graphical representation which is actionable by a user of the mobile device;
responsive to detection of actuation of the graphical representation, depicting the targeted advertisements linked to the graphical representation;
wherein, the targeted advertisements are relevant and specific to a contextual state of the mobile device.

19. The method of claim 18 wherein, the targeted advertisement is depicted along with third party content.

20. The method of claim 18, wherein, the contextual state is related to an application which is active on the mobile device.

21. The method of claim 18, wherein, the user environment is further populated with graphical user representations of multiple contacts accessible at the mobile device.

22. The method of claim 18, wherein, the graphical representation is depicted among multiple graphical representations shown in the form of a carousel of a sequence of images, wherein, the carousel is manipulable via a scrolling action to view the multiple graphical representations and additional graphical representations not depicted in the user environment.

23. The method of claim 18,
further depicting representations of multiple contacts in the user environment;
responsive to detecting a selection of a given representation associated with a contact, presenting modes of communication channels represented by graphical indicators in the user environment.

24. A system for enabling single action access to content via a mobile device, the method, the system comprising:
means for, depicting in a user environment on the mobile device, a graphical representation which is actionable by a user of the mobile device;
means for, depicting the content linked to the graphical representation responsive to detection of the single action activation of the graphical representation;
wherein, the content is relevant and specific to a user of the mobile device;
wherein, the graphical representation is depicted among multiple graphical representations shown in the form of a carousel having a sequence of images, wherein, the carousel is manipulable via a scrolling action.

25. The system of claim 24, further comprising, means for, selecting content sources from which to aggregate the content depicted on the mobile device based contextual state of the mobile device.

26. The system of claim 24, wherein, the content is further relevant and specific to a contextual state of the mobile device.
